(19) United States
(12) Patent Application Publication
(10) Pub. No.: US 2022/0366800 A1
(43) Pub. Date: Nov. 17, 2022

(54) METHOD AND APPARATUS FOR AIR SPACE HAZARD IDENTIFICATION AND ALERTING

(71) Applicant: UNIVERSITY OF NORTH TEXAS, Dallas, TX (US)

(72) Inventor: Kamesh NAMUDURI, DALLAS, TX (US)

(21) Appl. No.: 17/741,781

(22) Filed: May 11, 2022

Related U.S. Application Data
(60) Provisional application No. 63/187,495, filed on May 12, 2021.

(51) Int. Cl. G08G 5/04; G08G 5/00; G06N 20/00

(52) U.S. Cl. CPC G08G 5/045; G08G 5/0056; G08G 5/0069; G06N 20/00

(57) ABSTRACT

An air hazard alerting method includes acquiring information on one or more events within an airspace, analyzing the information to identify one or more air hazards within the airspace, generating an alert identifying the one or more air hazards, and sending the alert to at least one aircraft within the airspace. The information can be analyzed using one or more machine learning models.

### CROSS-REFERENCES TO RELATED APPLICATIONS

This application claims the benefit of U.S. Provisional Application No. 63/187,495, filed on May 12, 2021, and entitled “METHOD AND APPARATUS FOR AIR SPACE HAZARD IDENTIFICATION AND ALERTING,” which is incorporated herein by reference in its entirety for all purposes.

### STATEMENT REGARDING FEDERALLY SPONSORED RESEARCH OR DEVELOPMENT

None.

### BACKGROUND

Aircraft flying with an airspace can encounter a variety of hazards. The hazards can be communicated to the aircraft manual via warning to pilots, which can then alter their course to avoid the hazards. For example, ground controllers can contact pilots and convey information on storms that should be avoided, and the pilots can alter course to avoid the storms as needed.

### SUMMARY

In some embodiments, an air hazard alerting method comprises acquiring information on one or more events within an airspace, analyzing the information to identify one or more air hazards within the airspace, generating an alert identifying the one or more air hazards, and sending the alert to at least one aircraft within the airspace.

In some embodiments, an air hazard alerting system comprises a processor and a memory storing an alerting application. The alerting application, when executed on the processor, configures the processor to: receive information for one or more events within an airspace, analyze the information to identify one or more air hazards within the airspace, generate an alert identifying the one or more air hazards, and transmit the alert to at least one aircraft within the airspace.

These and other features will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a schematic representation of an airspace hazard.

FIG. 2 illustrates a flowchart for airspace hazard identification and alerting according to an embodiment.

FIG. 3 illustrates a schematic representation of a system for airspace hazard identification according to an embodiment.

FIG. 4 illustrates a schematic representation of a computer according to some embodiments.

### DETAILED DESCRIPTION

An air space hazard is a 3D volume of space that is unsafe for a drone or an Unmanned Aerial Vehicle (UAV) or Unmanned Aircraft System (UAS) to enter and/or continue to stay during its flight. In the case of a manned aircraft, the pilot may be able to see, sense, and avoid an airspace that is potentially dangerous. For a UAV, an automated strategy for identifying and alerting is necessary for safety reasons.

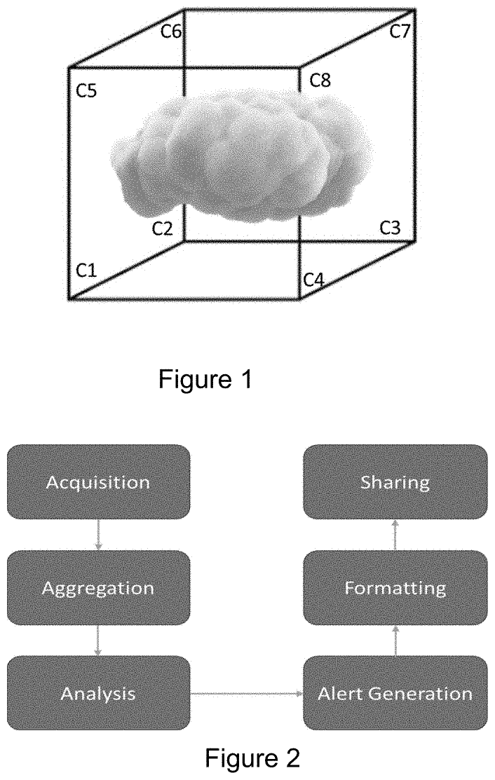

Various representations of an airspace hazard can be used. In some aspects, an airspace hazard is defined as a 3D volume of an air space described and represented coordinates of the boundaries of the 3D volume. In some aspects, the airspace hazard is represented as the smallest rectangular cuboid that contains this volume. The cuboid itself can be uniquely represented by its eight corners (C1 to C8) as shown in FIG. 1. Each corner itself is denoted by three dimensional coordinates such as a latitude, longitude, and elevation. In Federal Aviation Authority (FAA) terminology, the airspace that is reserved is referred to as UAS Volume Reservation (UVR). An airspace hazard is an example of UVR and it fits into the FAA's standard terminology. Airspace hazards can easily be integrated with existing UAV traffic management systems such as the UAS Traffic Management (UTM) and Advanced Air Mobility (AAM) systems.

The airspace hazard can generally be identified for any occurrence or action that can create a threat to the aircraft. The airspace hazards can be static or dynamic. In some aspects, airspace hazards can be identified for various situations or events such as, but not limited to, 1) Bad Weather, 2) Fire or Natural Disaster on the ground, 3) Security Threats, 4) Rogue aircrafts, 5) Safety and Privacy of People on the Ground, and (6) Communication Failures. In most situations, including those described herein, the airspace hazard can be represented in a standard UVR format.

The systems and methods described here can be used to identify airspace hazards and share this information with UAV, UAV operator, and/or other software systems and partners. In general terms, the proposed systems and methods involve identifying the airspace hazard and sharing this information in the form of an alert to humans, drones, and/or other software and hardware systems.

Upon the detection and/or identification of an airspace hazard, one or more alerts can be generated. Each alert can contain the UVR corresponding to the airspace hazard. In some aspects, the alert can also contain related information such as the begin and end time of the alert, cause of the alert, and its severity. The data can be included within the alert itself, and in some instances may be provided as meta data associated with the alert and UVR. In some aspects, alerts about airspace hazards can be sent in real-time (with zero delay) or near real time in industry standard message formats such as JSON (Java Script Object Notation)/REST (Representational State Transfer) API (Application Programming Interface) messages, and the like. As used herein, near real time refers to the sending and receipt of messages taking the various system and communication latencies into account, and can include communicating a message within about 1 minute, within about 5 minutes, or within a greater time as provided by the communication capabilities and bandwidth of the system.

Also disclosed herein is a method for generating alerts. In some aspects, the system can gather information from a variety of sources, aggregate this information, and share the information with UAVs and their operators using industry-standard formats. For example, for identifying weather related airspace hazards, sources can include local/regional weather providers, micro-weather service providers, weather detection sensors and systems (e.g., local lightning detectors), and/or weather stations deployed on UAVs. Information related to communication failures can be obtained from various service providers such as cellular communication data service providers. Information sources can vary as they depend on the type of airspace hazard that is being identified and shared. The proposed general method for airspace hazard identification and alerting can contain the following steps.

A) Acquisition of information;
B) Aggregation of information;
C) Analysis of information;
D) Alert generation;
E) Formatting using industry standards; and
F) Sharing the alerts.

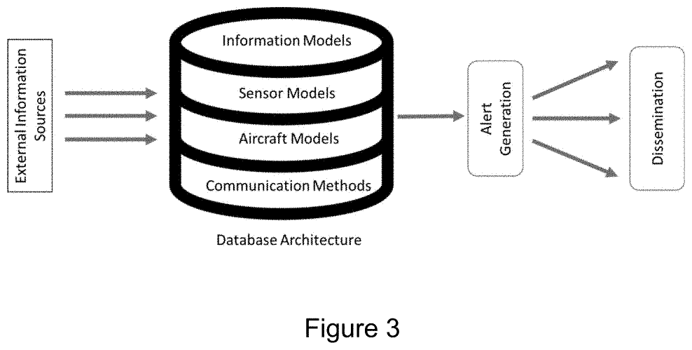

Also disclosed herein is an apparatus and system for airspace hazard identification and communication. The system used for implementing the airspace hazard identification and alerting service for UAVs is shown in FIG. 3 and can include one or more of the following:

### A) Database Architecture on the Ground (Distributed/Centralized/Cloud-based)

B) Packet Structure: Type of alert, severity level, impacted region in the airspace, details such as alternative routes, ways to avoid the danger, etc.

### C) Communication Methods: Ground to Air and Air to Air

### D) Information Models

### E) Sensor Models

### F) Aircraft Models

Each of the elements of the system can be implemented as one or more processor enabled devices (e.g., comprising a processor, memory, etc.). As illustrated in FIG. 3, the database or processing system can receive information from one or more external sources. The information can include any information on the airspace hazards, hazard locations, aircraft parameters, flight paths, regulations, and the like. Within the database or processing system, one or more models can be used as part of the alerting system. The various models can include information models, sensor models, and/or aircraft models. The information models can be used to extract, format, and process the information from the one or more information sources. For example, the information models can be used to combine data from multiple sources and process the data to identify potential airspace hazards. Similarly, the sensor and aircraft models can be used to provide information and analysis of the sensor outputs based on ground information and/or sensors aboard the UAV. Various types of models such as correlations, formatting routines, machine learning models, and the like can be used as the models in the system.

The communication methods and devices can include the communication equipment, standards, and processing equipment to produce the alerts and communicate the alerts to the UAVs and other systems. The communication methods and systems can also be responsible for receiving the information from the external sources as well as receiving inputs from the UAVs.

Once the appropriate information has been processed, the resulting output can include one or more alerts. The alerts can be formatted and processed in the alert generation portion, which can be implemented in software and/or hardware. The resulting alerts can be disseminated using various networks, broadcasting equipment, or wireless communication systems to send the alerts to the appropriate devices for communication to the UAVs. In some aspects, the alerts or other data can be communicated using various protocols such as the V2V communication protocols.

In some aspects, the system can primarily be a cloud-based software service. Interfaces among various airspace components can follow the ASTM, JSON and REST standard and style specifications. Communications to and from the UAS platform will be through embedded systems such as the Jetson Nano or Raspberry PI. IEEE P1920.2 standards will be used for over-the-air V2V Communications between UASs. Power for the embedded systems can be drawn from the vehicle itself.

Upon receiving an alert, a UAV may process the alerts or other messages and avoid the airspace hazards based on the coordinates in the alerts.

The proposed method can be implemented as a supplementary service for UAVs, UAV operators, and other software and hardware systems within the ecosystem of air traffic management. The alerts can be generated and provided as a service that can be offered for those who subscribe to this service.

In some aspects, a system as described herein can provide a comprehensive framework for acquiring information related to static and dynamic airspace hazards (including weather, communications, platform, sensors, security, among others as described herein), and share this information with the platforms, operators, and other stakeholders of Advanced Air Mobility (AAM) ecosystem in real-time or near real time using various communication standards (e.g., ASTM and/or V2V standards).

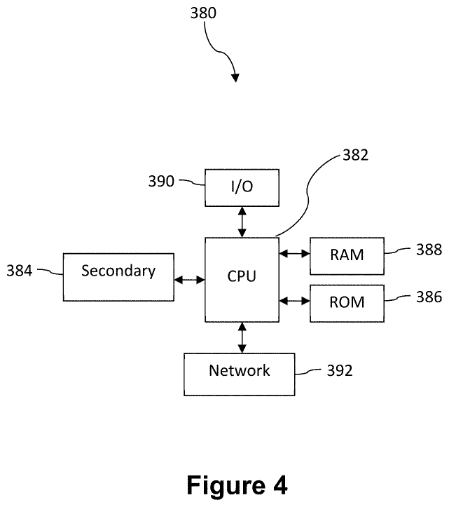

FIG. 4 illustrates a computer system 380 suitable for implementing one or more embodiments disclosed herein, such as the alerting system and/or one or more processor-based systems within the communication system and/or UAVs. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

Having described various systems and methods, certain aspects can include, but are not limited to:

In a first aspect, an air hazard alerting method comprises: acquiring information on one or more events within an airspace; analyzing the information to identify one or more air hazards within the airspace; generating an alert identifying the one or more air hazards; and sending the alert to at least one aircraft within the airspace.

A second aspect can include the method of the first aspect, wherein the information is acquired from a plurality of sources, and wherein the method further comprises: aggregating the information from the plurality of sources to generate aggregated information, wherein analyzing the information comprises analyzing the aggregated information.

A third aspect can include the method of the first or second aspect, further comprising: formatting the alert to one or more industry standards prior to sending the alert.

A fourth aspect can include the method of any one of the first to third aspects, wherein the one or more air hazards comprise at least one of: a weather event, a natural disaster, a security threat, a rogue aircraft, a safety event, or a communication failure.

A fifth aspect can include the method of any one of the first to fourth aspects, wherein the at least one aircraft comprises an unmanned aircraft system.

A sixth aspect can include the method of any one of the first to fifth aspects, wherein the alert identifies a volume of the airspace containing the one or more air hazards.

A seventh aspect can include the method of the sixth aspect, wherein the alert defines the volume using boundary coordinates of the volume.

In an eighth aspect, an air hazard alerting system comprises: a processor; and a memory storing an alerting application, wherein the alerting application, when executed on the processor, configures the processor to: receive information for one or more events within an airspace; analyze the information to identify one or more air hazards within the airspace; generate an alert identifying the one or more air hazards; and transmit the alert to at least one aircraft within the airspace.

A ninth aspect can include the system of the eighth aspect, wherein the information is received from a plurality of sources, and wherein the processor is further configured to: aggregate the information from the plurality of sources to generate aggregated information, wherein the analysis of the information comprises an analysis of the aggregated information.

A tenth aspect can include the system of the eighth or ninth aspect, wherein the processor is further configured to: format the alert to one or more industry standards prior to sending the alert.

An eleventh aspect can include the system of any one of the eighth to tenth aspects, wherein the one or more air hazards comprise at least one of: a weather event, a natural disaster, a security threat, a rogue aircraft, a safety event, or a communication failure.

A twelfth aspect can include the system of any one of the eighth to eleventh aspects, wherein the at least one aircraft comprises an unmanned aircraft system.

A thirteenth aspect can include the system of any one of the eighth to twelfth aspects, wherein the alert identifies a volume of the airspace containing the one or more air hazards.

A fourteenth aspect can include the system of the thirteenth aspect, wherein the alert defines the volume using boundary coordinates of the volume.

A fifteenth aspect can include the system of any one of the eighth to fourteenth aspects, wherein the processor is further configured to analyze the information using one or more information models, sensor models, or aircraft models.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicant(s) hereby give notice that new claims may be formulated to such features and/or combinations of such features during the prosecution of the present Application or of any further Application derived therefrom.

What is claimed is:

1. An air hazard alerting method, the method comprising:
acquiring information on one or more events within an airspace;
analyzing the information to identify one or more air hazards within the airspace;
generating an alert identifying the one or more air hazards; and
sending the alert to at least one aircraft within the airspace.

2. The method of claim 1, wherein the information is acquired from a plurality of sources.

3. The method of claim 2, further comprising:
aggregating the information from the plurality of sources to generate aggregated information, wherein analyzing the information comprises analyzing the aggregated information.

4. The method of claim 1, further comprising:
formatting the alert to one or more industry standards prior to sending the alert.

5. The method of claim 1, wherein the one or more air hazards comprise at least one of: a weather event, a natural disaster, a security threat, a rogue aircraft, a safety event, or a communication failure.

6. The method of claim 1, wherein the at least one aircraft comprises an unmanned aircraft system.

7. The method of claim 6, wherein the unmanned aircraft system comprises a drone or an Unmanned Aerial Vehicle (UAV) or Unmanned Aircraft System (UAS).

8. The method of claim 1, wherein the alert identifies a volume of the airspace containing the one or more air hazards.

9. The method of claim 8, wherein the alert defines the volume using boundary coordinates of the volume.

10. An air hazard alerting system, the system comprising:
a processor; and
a memory storing an alerting application, wherein the alerting application, when executed on the processor, configures the processor to:
receive information for one or more events within an airspace;
analyze the information to identify one or more air hazards within the airspace;
generate an alert identifying the one or more air hazards; and
transmit the alert to at least one aircraft within the airspace.

11. The system of claim 10, wherein the information is received from a plurality of sources.

12. The system of claim 10, wherein the processor is further configured to:
aggregate the information from the plurality of sources to generate aggregated information, wherein the analysis of the information comprises an analysis of the aggregated information.

13. The system of claim 10, wherein the processor is further configured to:
format the alert to one or more industry standards prior to sending the alert.

14. The system of claim 10, wherein the one or more air hazards comprise at least one of: a weather event, a natural disaster, a security threat, a rogue aircraft, a safety event, or a communication failure.

15. The system of claim 10, wherein the at least one aircraft comprises an unmanned aircraft system.

16. The system of claim 15, wherein the unmanned aircraft system comprises a drone or an Unmanned Aerial Vehicle (UAV) or Unmanned Aircraft System (UAS).

17. The system of claim 10, wherein the alert identifies a volume of the airspace containing the one or more air hazards.

18. The system of claim 17, wherein the alert defines the volume using boundary coordinates of the volume.

19. The system of claim 10, wherein the processor is further configured to analyze the information using one or more information models, sensor models, or aircraft models.

20. The system of claim 10, wherein the processor is further configured to analyze the information using one or more machine learning models.
